(19) United States
(12) Patent Application Publication
(10) Pub. No.: US 2023/0142159 A1
(43) Pub. Date: May 11, 2023

(54) STAND-ALONE MINIATURE IN-SITU MULTIAXIAL UNIVERSAL TESTING EQUIPMENT (IsMUTE)

(71) Applicant: INDIAN INSTITUTE OF TECHNOLOGY MADRAS (HT MADRAS), Chennai (IN)

(72) Inventors: LALITH KUMAR B, Chennai (IN); GOBIND KUMAR, Chennai (IN); RAVI KUMAR N.V, Chennai (IN)

(73) Assignee: INDIAN INSTITUTE OF TECHNOLOGY MADRAS (HT MADRAS), Chennai (IN)

(21) Appl. No.: 17/912,828

(22) PCT Filed: Mar. 18, 2021
(86) PCT No.: PCT/IN2021/050277

§ 371 Date: Sep. 19, 2022

(30) Foreign Application Priority Data
Mar. 20, 2020 (IN) 202041012088

(51) Int. Cl. G01N 3/06; G01N 3/08

(52) U.S. Cl. CPC G01N 3/068; G01N 3/08; G01N 2203/0254; G01N 2203/0256; G01N 2203/0647

(57) ABSTRACT

A stand-alone miniature in-situ multiaxial universal testing equipment, is disclosed herein. The device comprises a multi-axial loading fixture unit, a data processing unit, an image capturing unit, a data acquisition unit, motor unit, loading jaw, loading heads, displacement sensor, lighting unit and telecentric lens. The device is a stand-alone, in-plane, in-situ miniaturized multiaxial loading fixture that is capable of loading a wide variety of samples including but not limited to, metallic, ceramics and composites.. The loading fixture is capable of in-plane tension, in-plane compression in one-direction or two directions both independently and simultaneously and as well 4-point bending loading of the samples.

### CROSS-REFERENCE TO RELATED APPLICATIONS

This application claims priority to PCT Application No. PCT/IN2021/050277, filed on Mar. 18, 2021, entitled “STAND-ALONE MINIATURE IN-SITU MULTIAXIAL UNIVERSAL TESTING EQUIPMENT (ISMUTE),” which claims priority to Indian Patent Application Number 202041012088, filed on Mar. 20, 2020, entitled “STAND-ALONE MINIATURE IN-SITU MULTIAXIAL UNIVERSAL TESTING EQUIPMENT (ISMUTE)”. The contents of the aforementioned patent applications are hereby expressly and fully incorporated by reference in their entirety, as though set forth in full.

### TECHNICAL FIELD

The present invention generally relates to universal testing machines and equipment. The present invention is additionally related to material testing and characterization techniques. The present invention also relates to in-situ multiaxial universal testing equipment. The present invention specifically relates to development of a stand-alone, in-plane, in-situ miniature multiaxial loading fixture that is capable of loading the sample (metallic, ceramics and composites) in one direction as well as two directions both independently and simultaneously.

### BACKGROUND OF THE INVENTION

Universal Testing Machines (UTMs) for obtaining mechanical properties of engineering materials for the safe and reliable design of structural elements is well-known in the art for performance critical applications. For example, such universal testing machines and equipment are adapted to measure the uniaxial tensile/compression of metallic materials. Similarly, 3-point/4-point bending test is adapted for testing ceramic materials for reliable design of structural elements. Furthermore, multi-axial stress/strain states are measured in real-life service and processing conditions.

In majority of metal forming operations such as for example stretch forming and stamping processes the metals/materials are prone to experience biaxial stress state. In addition, strain-path changes are also encountered during sheet forming of the metals/materials. It is therefore important for testing the formability of such materials under complex strain path changes which is critical for safe and reliable structural design applications. Furthermore, superior ballistic performances are observed for ceramic materials that are under confinement stresses (equi-biaxial compression) and are attributed to the delayed onset of brittle fracture. In addition, ceramics show ductile deformation mechanisms operating under the presence of confinement stress. It is therefore, investigating the fracture behaviour of ceramics under complex biaxial confinement stresses has also become highly critical.

Conventionally, hardening models and constitutive relations are proposed to describe the material behaviour in such applications. However, such conventional approaches and models are unable to render promising results while testing advanced high strength steels and alloys with complex strains. Also, such prior art approaches require additional data relating to multiaxial stress states for validating the crystal plasticity finite element (FE) models which elucidates microstructural and textural evolution upon deformation. Multi-axial universal testing equipment is introduced to overcome the above disadvantages associated with the conventional models.

In one embodiment of prior art multiaxial loading techniques, Marciniak punch test approach is proposed [1,2]. The other approach proposes variations including combinations of uniaxial tension/compression-torsion-bending-shear-indentation [3,4] and in-plane biaxial tension/compression loading [5-9]. Although each of the prior art technique has its own merits and drawbacks, in particular, the in-plane biaxial loading technique gained much popularity due to its stress-strain responses under any arbitrarily chosen biaxial load-ratios using one-unique cruciform specimen geometry. Also, the simplicity of the in-plane multiaxial experiment to obtain the material data was a major advantage. The in plane biaxial testing has been also used for low and medium strains as well as for strains up until fracture of materials.

The biaxial test setups using cruciform specimen geometry can be broadly classified into stand-alone biaxial testing machine [7,8,10] and link mechanism [5,6,11] based on their design. The link mechanism was primarily introduced to reduce the cost associated with the fabrication; however, the link mechanism does not permit the controlled strain path changes without unloading of the material tested. The stand-alone biaxial testing machines are designed with the capability of static and dynamic loading as well as in-built temperature controllers. Though the macroscopic responses of the material under biaxial loading were studied, it is also equally important to understand the influence of stress state on microscopic phenomenon such as slip, twinning and phase transformations respectively.

An in-situ miniature multi-axial testing equipment is required to be used along with characterization techniques, such as, optical microscopy, Raman spectroscopy, X-ray diffractograms and scanning electron microscopy. A very few state-of-the art miniature multiaxial loading fixture designs are known in the art [12,13]. In one embodiment of the prior art miniature multiaxial loading fixture design, the area under observation does not always remain at the center during loading of the material which becomes cumbersome when a specific region of interest is observed under the microscopes. Such prior art design in unable to offer high loading capacities. In another embodiment of prior art, the design proposes a single motor for each direction and not for each loading arm, which reduces the flexibility of the machine and the range of experiments that can be done. Moreover, the range of cross head travel is less than 15 mm for such a prior art design. Also, the prior art solutions are unable to provide a clamping held for biaxial compression and therefore unable to provide effective tension and compression test on the material/metals.

Commercially available loading fixtures are used to obtain material properties such as stress vs strain profiles, elastic moduli, yield strength, Poisson’s ratio, R-value and ultimate tensile strength of a material. ASTM and ISO standards exist for bulk testing of materials. However, standard bulk testing techniques cannot always be used for materials with a gradient microstructure resulting from various manufacturing & joining methods. Also, development of novel materials with constrained volume and multi-layered coatings mandates small scale testing. Some of the applications also require biaxial testing for accurate description of the deformation behaviour. Hence, small scale testing coupled with possibilities of in situ multi-axial testing provides solutions to various engineering requirements.

Based on the foregoing arguments there is a need for an improved standalone miniature multiaxial loading fixture with the capability of testing materials under uniaxial/biaxial tension/compression and 4-point bending loading along with the sample optimization. Also, a stand-alone, in-plane miniature in-situ multiaxial universal testing equipment for testing materials, as discussed in greater detail herein.

References:
1. CN205027613U U - Sheet forming performance measurement device
2. FR3039274 B1 - Mechanical testing machine in-situ of stamping and folding
3. US 8082802 B1 - Compact and stand-alone combined multi-axial and shear test apparatus
4. US 10444130 B2 - Material in-situ detection device and method under multi-load and multi-physical field coupled service conditions
5. FR2875907 B1 - Motor-driven tensile testing apparatus subjecting polymer or elastomer to biaxial field of deformation, has pairs of opposed jaws with system correlating orthogonal separation
6. JP07238792 A - Biaxial tension test device
7. US 7712379 B - Uniaxially-driven controlled biaxial testing fixture
8. CN 104568591 - Biaxial extension test device
9. JP2018080923 A - Biaxial compression and tension testing jig and biaxial compression and tension testing method
10. WO 2005/040765 A3 - Multiaxial universal testing machine
11. EP3335026 A1 - Planar test system
12. CN102645370 A - Biaxial stretching/compression mode scanning electron microscope mechanical test device
13. WO2014108615 A1 - Machine for biaxial mechanical tests

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

Therefore, one aspect of the disclosed embodiment is to provide for an improved in-situ multiaxial universal testing equipment.

It is further aspect of the disclosed embodiment to provide for an improved stand-alone miniature multiaxial loading fixture with the capability of testing materials under uniaxial/biaxial tension/compression loading as well as miniature 4-point bending along with the sample optimization for all the above.

It is particular aspect of the disclosed embodiment to provide for an improved stand-alone, in-plane miniature in-situ multiaxial universal testing equipment for testing materials.

The aforementioned aspects and other objectives and advantages can now be achieved as described herein. A stand-alone miniature in-situ multiaxial universal testing equipment, is disclosed herein. The device comprises a multiaxial loading fixture unit, a data processing unit, an image capturing unit, a data acquisition unit, motor unit, loading jaw, loading heads, displacement sensor, lighting unit and telecentric lens. The device is a stand-alone, in-plane, in-situ miniaturized multiaxial loading fixture that is capable of loading a wide variety of samples including but not limited to, metallic, ceramics and composites in one direction or two directions both independently and simultaneously. The loading fixture is capable of both in-plane tension and in-plane compression as well as 4point bending loading of the samples.

A maximum loading capacity of 7.5 kN and strain rates between 10⁻⁴ /s to 10⁻² /s can be achieved and the fixture can operate in both displacement controlled and load-controlled modes using PID (Proportional-Integral-Differential). Each arm of the loading fixture has a travel range of 30 mm and the displacement is measured using a strain gauge-based displacement sensor. Full field strain is measured by digital image correlation using the image capturing unit attached to the fixture. The fixture is designed to be compatible for in-situ experiments by integrating it with X-ray diffractometer, Raman spectrometer and optical microscope. The device proposed herein with its compact design and loading fixture has high loading capacity and variable loading rates and is also capable of both uniaxial and biaxial experiments.

### BRIEF DESCRIPTION OF DRAWINGS

The drawings shown here are for illustration purpose and the actual system will not be limited by the size, shape, and arrangement of components or number of components represented in the drawings.

FIG. 1 illustrates a schematic view 100 of the stand-alone miniature in situ multiaxial universal testing equipment, in accordance with the disclosed embodiments;

FIG. 2 illustrates a schematic view of the in-situ biaxial deformation device 200, in accordance with the disclosed embodiments;

FIG. 3 illustrates a schematic view 300 of the motor and motor bracket assembly (6), in accordance with the disclosed embodiments;

FIG. 4 illustrates a schematic view 400 of the gear box (7) and guide rails (8), in accordance with the disclosed embodiments;

FIG. 5(a) and 5(b) illustrates a schematic view 500 of the jaw assembly and loading heads, in accordance with the disclosed embodiments;

FIG. 6 illustrates a schematic view of the displacement sensor unit, in accordance with the disclosed embodiments;

FIG. 7 illustrates a schematic view of the image capturing unit, in accordance with the disclosed embodiments; and

FIG. 8 illustrates a schematic view 800 of the lighting unit, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

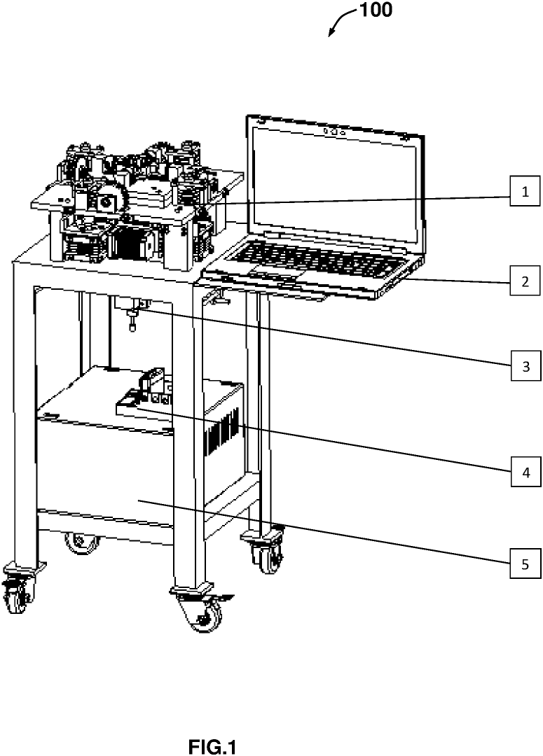

FIG. 1 illustrates a schematic view 100 of the stand-alone miniature in situ multiaxial universal testing equipment, in accordance with the disclosed embodiments. The device comprises a multi-axial loading fixture unit (1), a data processing unit (2), an image capturing unit (3), a data acquisition unit (4), motor unit (5), loading jaw, loading heads, displacement sensor, lighting unit and telecentric lens. The device 100 is a stand-alone, in-plane, in-situ miniaturized multiaxial loading fixture that is capable of loading a wide variety of samples including but not limited to, metallic, ceramics and composites in one-direction or two directions both independently and simultaneously. The loading fixture unit (1) is capable of both in-plane tension and in-plane compression loading of the samples.

A maximum loading capacity of 7.5 kN and strain rates between 10⁻⁴ /s to 10⁻² /s can be achieved and the fixture (1) can operate in both displacement controlled and load-controlled modes using PID (Proportional-Integral differential). Each arm of the loading fixture (1) has a travel range of 30 mm and the displacement is measured using a strain gauge-based displacement sensor. Full field strain is measured by digital image correlation using the image capturing unit attached to the fixture (1). The fixture (1) is designed to be compatible to in-situ experiments integrating with X-ray diffractometer, Raman spectrometer and optical microscope. The device 100 proposed herein with its compact design and loading fixture has high loading capacity and variable loading rates and is also capable of both uniaxial and biaxial experiments.

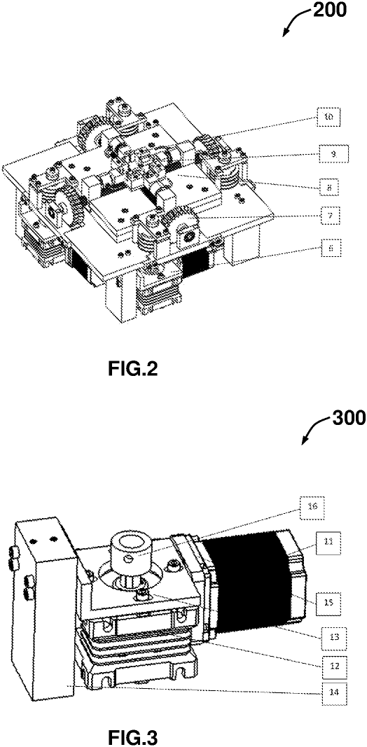

FIG. 2 illustrates a schematic view of the in-situ biaxial deformation device 200, in accordance with the disclosed embodiments. The loading fixture unit (1) comprises motor and motor bracket assembly (6), gear box (7), guide rails (8), loading jaw (9) and displacement sensor (10).

FIG. 3 illustrates a schematic view 300 of the motor and motor bracket assembly (6), in accordance with the disclosed embodiments. The assembly (6) comprises a stepper motor (11) with capacity of 2 N-m and a least step angle of 1.8⁰ with low speed and large torque. The motor (11) mounted to a worm gear box (12) which is in turn mounted using a L-bracket (13) onto a support block (14). A NEMA 23 motor dampener (15) is attached in between the L-bracket (13) and support block (14). The output shaft from the gearbox is attached to a secondary gearbox (7) using a jaw coupling (16). The gear ratio in total for loading fixture is 1:260.

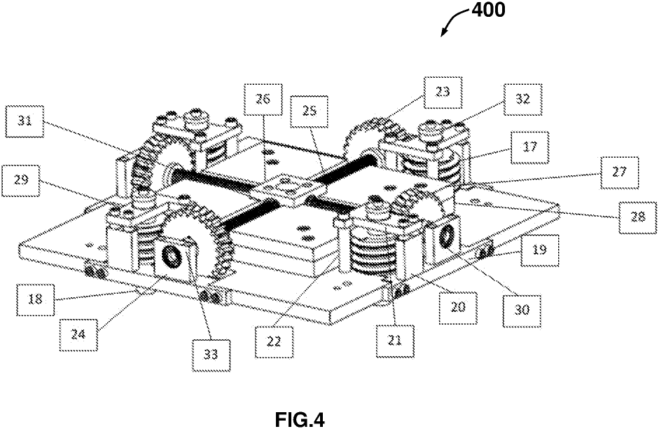

FIG. 4 illustrates a schematic view 400 of the gear box (7) and guide rails (8), in accordance with the disclosed embodiments. The reduction in speed and increase in torque is achieved using a worm gear with 1:26 worm gear ratio. The minimum distance movement that can be achieved with such a configuration is 0.8 µm and a maximum load capacity of 5 kN. The worm (17) was coupled to jaw (16) coupling using a gear rod (18). The worm (17) is made of EN8 steel. The entire gear assembly was mounted on to a base plate (19) using support plate (20), (21) and support cylinder (22). The worm gear (23) was also mounted on the base plate (19) using a support plate (24). The worm gear (23) is made of phosphor bronze. The lead screw rod (25) is coupled to the worm gear (23) and is supported in the centre using support block (26). The other side of the lead screw is supported by support plate (24). The lead screw rod (25) is designed with a hardened D2 tool steel and M16*3 mm pitch ACME threads to achieve least movement. Meanwhile, the lead screw rod (25) is designed with a self-locking function so as to realize dynamic and static observation modes during in-situ experiment. With such a lead screw arrangement each arm can achieve a maximum travel of 40 mm. The guide rails (8) are composed of two plates, top guide rail (27) and bottom guide rail (28) which were tightened together to form a T-slot for the loading jaw (9) to move. The guide rails (8) are made of D2 tool steel without heat treatment. The guide rails (8) were surface grinded to very low surface roughness for the easy movement of the loading jaw. The ball bearing (29), (30), (31) are tight fitted to the support plates (21), (24) and support block (26) respectively. The vertical motion of the worm (17) is locked using a thrust bearing assembly (32) that is mounted on the either side of support plate (21). Similarly, the horizontal motion of the lead screw rod (25) is locked by the support block (26) on one side and a thrust bearing (33) on the other side which is supported by the support plate (24).

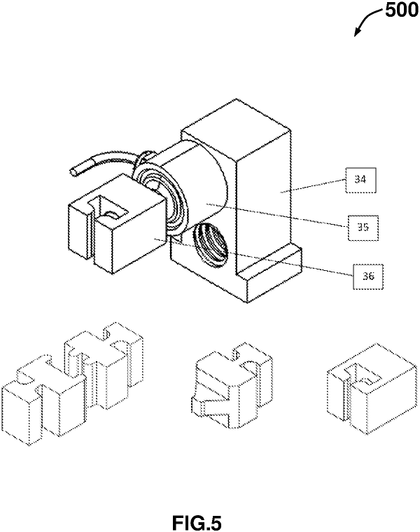

FIG. 5(a) and 5(b) illustrates a schematic view 500 of the jaw assembly and loading heads, in accordance with the disclosed embodiments. The loading unit (1) contains three-parts slide block (34), load cell (35) and loading head (36). The slide block (34) is coupled to the loading screw (25) and it houses the load cell (35) and loading head (36). The slide block (34) is made of hardened D2 tool steel and is made to move in the T-slot of guide rails (8) using screw nut assembly of loading screw (25) and slide block (34) respectively. One load cell (35) is present on each X axis and Y axis of the test apparatus. Its design is double screw end and both tensile and compressive load can be measured. The transducer adopts a foil gage attached against an alloy steel. The load cell has high measuring precision, favorable stability, small temperature drift and good output symmetry with a compact structure. The load cell operates at excitation voltage of 2.5 V and has an ohmic resistance on 350 Ω.

The loading heads (36) are designed in such a way such that they are interchangeable and can be swapped between tension and compression module. The loading heads (36) are made up of hardened D2 tool steel and ground to very fine surface roughness. A common problem associated with miniature tensile experiments is that the clamping stresses influence the stress-strain curve. In order to avoid such complexity wraparound clamping unit is used. FIG. 5b. shows the wraparound tensile (36) loading head used for miniature tensile experiments. The tolerance between the clamping head and sample is less than 0.1 mm. A greater tolerance results in unnecessary deformation from the ends of the sample thereby influencing the stress strain curve.

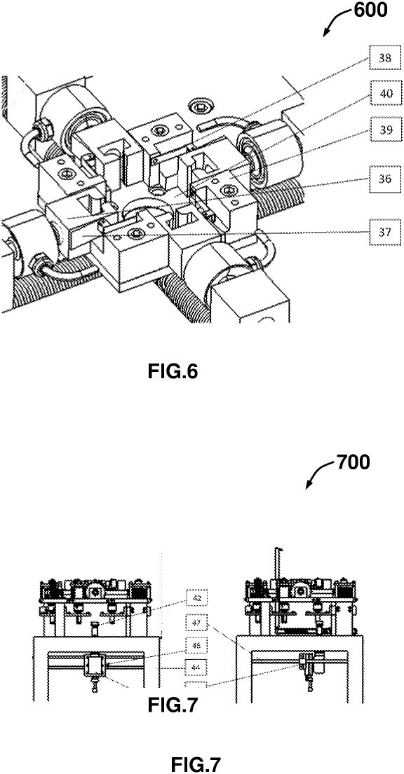

FIG. 6 illustrates a schematic view of the displacement sensor unit, in accordance with the disclosed embodiments. The custom built (10) displacement sensor works on the principle of strain measured on a cantilever. FIG. 6, shows the magnified view of the displacement sensor that is housed in the centre of the fixture. The (36) loading head has a (37) wedge shaped structure with a constant taper, it pushes the (38) cantilever differentially when it goes forward or backward. The (38) cantilever is tightened to the (39) support block. All the (39) supported blocks are tightened to a (40) base plate. Strain gauges are attached to the (38) cantilever, the variation in strain is directly related to the amount of displacement of the loading head. The strain gauges in the opposite heads are connected series so as to reduce the errors. As a result, the total displacement in one axis is the sum of change in resistances of the strain gauges connected in series.

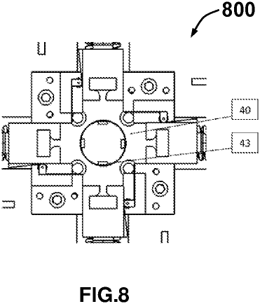

FIG. 7 illustrates a schematic view of the image capturing unit, in accordance with the disclosed embodiments. In order to acquire full field strain DIC (Digital Image Correlation) is used. The various components of the camera assembly are camera (41), telecentric lens (42), lighting system (43), stand (44) to hold the camera assembly, brackets (45) for x-axis and y-axis movement of the camera and precision stage (46) for z-axis movement of the camera. The x-axis and y-axis brackets rest on a sliding rod (47) which is attached to the stand (44). The precision stage (46) can achieve a precise movement of ± 12 mm in the z-axis. Since the telecentric lens (42) is a fixed focal length lens the image is brought into focus using this precision stage.

FIG. 8 illustrates a schematic view 800 of the lighting unit, in accordance with the disclosed embodiments. The telecentric lens from Edmund optic with an optical zoom of 1 X and working distance of 110 mm was used. The reason for choosing a telecentric lens over a fixed focal lens is that its magnification does not change with respect to depth. For uniform lighting white LED is used and lighting is perpendicular to the optic axis. The lighting is housed in the inner diameter of support block (26). This arrangement proved to be the optimum lighting conditions as all other lighting condition resulted in erroneous error in the analysis of images.

The controllers for the motors can achieve micro-steps of 20000 steps per rotation for 1.8° in a stepper motor. A custom-built software using Lab VIEW is used to control the motors using an Arduino Mega 2560 R3 Board. For the case of Biaxial loading the machine is switched from a displacement-controlled mode to load controlled mode. A PID controller built in with Lab VIEW is used to achieve equi-biaxial loading conditions. The load output from one side of the loading axis is used to control the speed of the motors in the other axis to achieve equi-biaxial loading conditions. All biaxial experiments were done in load controlled, but is to be pointed out that biaxial experiments can be done in displacement controlled too.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A stand-alone miniature in-situ multiaxial universal testing equipment, comprising:
a multi-axial loading fixture unit (1);
a data processing unit (2);
an image capturing unit (3);
a data acquisition unit (4);
a motor unit (5);
loading jaw (9);
loading heads;
displacement sensor (10);
lighting unit; and
telecentric lens.

2. The device of claim 1 wherein the multi-axial loading fixture unit (1) is a stand-alone, in-plane, in-situ miniaturized multiaxial loading fixture that is capable of loading samples (metallic, ceramics and composites) in one direction or two directions both independently and simultaneously.

3. The device of claim 1 wherein the loading fixture unit (1) is configured for in-plane tension, in-plane compression and 4-point bending loading of the samples with maximum loading capacity of 7.5 kN and strain rates between 10-4 /s to 10-2 /s.

4. The device of claim 1 wherein the loading fixture unit (1) is configured to operate in both displacement-controlled and load-controlled modes using Proportional-lntegral-Differential) (PID).

5. The device of claim 1 wherein the loading fixture unit (1) comprises arms with travel range of 30 mm,
the device further comprising a custom built strain gauge based displacement sensor (10) configured to measure a displacement,
wherein the custom built strain gauge based displacement sensor (10) is configured to measure a minimum displacement of 0.005 mm.

6. The device of claim 1 wherein image capturing unit (3) is configured to measure a full field strain is by digital image correlation, and
wherein the image capturing unit (3) is attached to the loading fixture unit (1).

7. The device of claim 1 wherein the loading fixture unit (1) is configured to perform in-situ experiments integrating with an X-ray diffractometer, a Raman spectrometer, an optical microscope and a scanning electron microscope (SEM).

8. The device of claim 1 wherein the loading fixture unit (1) comprises:
a motor and motor bracket assembly (6);
a gear box (7);
guide rails (8);
a loading jaw (9); and
a displacement sensor (10).

9. The device of claim 1 wherein the loading fixture unit (1) comprises:
a slide block (34),
a load cell (35); and
a loading head (36).
